(19) United States
(12) Patent Application Publication
(10) Pub. No.: US 2009/0242326 A1
(43) Pub. Date: Oct. 1, 2009

(54) DESCENDING DEVICE

(75) Inventor: John Franklin Hayhurst, Stockport (GB)

Correspondence Address: GAUTHIER & CONNORS, LLP, 225 FRANKLIN STREET, SUITE 2300, BOSTON, MA, 02110, US

(73) Assignee: DONUT SAFETY SYSTEMS LIMITED, Stockport (GB)

(21) Appl. No.: 12/470,882

(22) Filed: May 22, 2009

Related U.S. Application Data
(63) Continuation of application No. PCT/GB2007/004719, filed on Dec. 11, 2007.

(30) Foreign Application Priority Data
Dec. 16, 2006 (GB) 0625125.0

(51) Int. Cl. A62B 35/00

(52) U.S. Cl. 182/5

(57) ABSTRACT

A device to enable a person to descend from an elevated position at a controlled and variable speed comprising a restraining member (12) having a series of slots (13). A tape (11) stored in a container (20) passes through the slots (13) to a hook (10) for attachment of the device to a fixed point. A user wearing a harness (21) removably attached to the restraining member (12) may descend at a controlled rate determined by the frictional engagement of the tape (11) with the surfaces of the restraining member (12). An apertured retarding device (50) is placed on the tape (11) within the container (20) to retard the passage of the tape through the restraining member (12) thus controlling the rate of descent.

### PRIORITY INFORMATION

This application is a continuation of International Application No. PCT/GB2007/004719 filed on Dec. 11, 2007 which claims priority to Great Britain Patent Application No. 0625125.0 filed on Dec. 16, 2006, all of which are incorporated by reference in their entirety herein.

### BACKGROUND OF THE INVENTION

1. Field of the Invention

This invention concerns a device to enable personnel or other loads to descend from an elevated position at a controlled and variable speed.

2. Brief Description of the Prior Art

Such a device may be used, for example, to permit rapid escape of personnel from upper storeys of buildings or other elevated locations and/or offshore oil/gas platforms, FPSOs, drilling rigs or ships. The device may be operated and controlled by the user himself or by other personnel for lowering casualties or other loads in a controlled manner.

Such a device is described in patent specification WO 90/04998 and comprises a harness attached to a restraining member through which may pass, at a controlled rate, a tape of sufficient length to enable an occupant to descend to the ground or other safe level, or, in an offshore application, into the sea.

This and other known devices for escape are uncontrollable to the extent that once the load is descending it does so at a controlled speed with no positive means of slowing or stopping it until it reaches a position of rest at a lower level. This may cause injury or be unsuitable when escaping from a burning building or other structure where it may be desired to remain suspended close to but above the ground or sea until rescue services arrive.

### SUMMARY OF THE INVENTION

An object of the present invention is to provide a simple and inexpensive device which may be attached to any fixed point at an upper level, and which is so compact as to be stored in numbers sufficient for the escape of all personnel present at that level. The device must be made ready for use immediately and may be incorporated into a safety harness or a survival suit containing a harness.

Canadian Patent No. 2,115,187 also discloses a descending device to enable personnel or other loads to descend from an elevated position at a controlled speed, comprising a restraining member to which the load may be attached and having therein a series of apertures through which passes in alternate directions a line such as a tape or rope, one or more edges of each aperture defining a contact surface providing frictional engagement for the line as the load descends, means for attachment of the line to a fixed point at said elevated position, and a container for a store of the line sufficient to permit the required descent. This device may have a retarding device in the form of a fabric washer positioned on the line at a predetermined location within the container to retard the passage of the line through the apertures of the restraining member.

The device according to the present invention is distinguished by the characterizing features of specified in claim 1.

There may be a restricted opening in the container for the controlled payout of line therefrom, the retarding device being larger than the restricted opening.

The size of the or each aperture may be less than that of the line.

The line may be a tape, and the or each aperture may be a slot of lesser width than that of the tape.

The retarding device may be formed such that the line may be introduced into the or each aperture therein without passing over the end of the line.

The retarding device may have an introductory slot communicating with the or each aperture therein.

Two or more such retarding devices may be located on the line at mutually spaced positions therealong.

Preferably, the load is a person and there is also included a harness to be worn by the person, which is adapted to be attached to the restraining member and to the container.

The harness may be of a so-called “nappy-type” or may consist of a waistband and crotch straps with means for attachment of the restraining member to at least one loop at the front of the waistband, whilst the container is attachable to a side region of the harness.

Still further, for offshore use the entire harness may be incorporated into a survival suit which may have provision for the container to be attached to the suit about the wearer's knee or any other accessible position.

### BRIEF DESCRIPTION OF THE DRAWINGS

Embodiments of the invention will now be described, by way of example only, with reference to the accompanying drawings, in which:

FIG. 1 is a general illustration of a known descending device as described in WO 90/04998;

FIG. 2 is an enlarged view of a restraining member forming part of the device illustrated in FIG. 1;

FIGS. 3a to 3d are respectively front, side and rear elevations and a plan view of part of the device as illustrated in FIG. 1;

FIGS. 4 & 5 are front and cross-sectional views of a retarding device in accordance with a first embodiment of the invention for use with the descending device; and

FIGS. 6 & 7 are enlarged perspective and exploded views of a second embodiment of the retarding device.

### DETAILED DESCRIPTION OF THE INVENTION

Referring now to the drawings, a descending device made in accordance with the invention comprises a spring-loaded hook 10 for attachment of the device to a fixed point at an elevated position from which a user is to descend. This may be, for example, a handrail, fixed bar or wall plate. Permanently fixed to the hook 10 is an upper looped end of a tape 11 which may be made from nylon or other synthetic material and should be designed to have a breaking strain in the region of 1000 kg (straight load). The tape is preferably brightly coloured in two or more fluorescent colours so as to be readily seen in conditions of poor visibility. Although not illustrated in the drawings, the tape may be provided with graduated markings at metre spacing so that it may be easily paid out to a predetermined length. Also, the tape may be date-coded by incorporating visual stitching representing a certain period or date of manufacture.

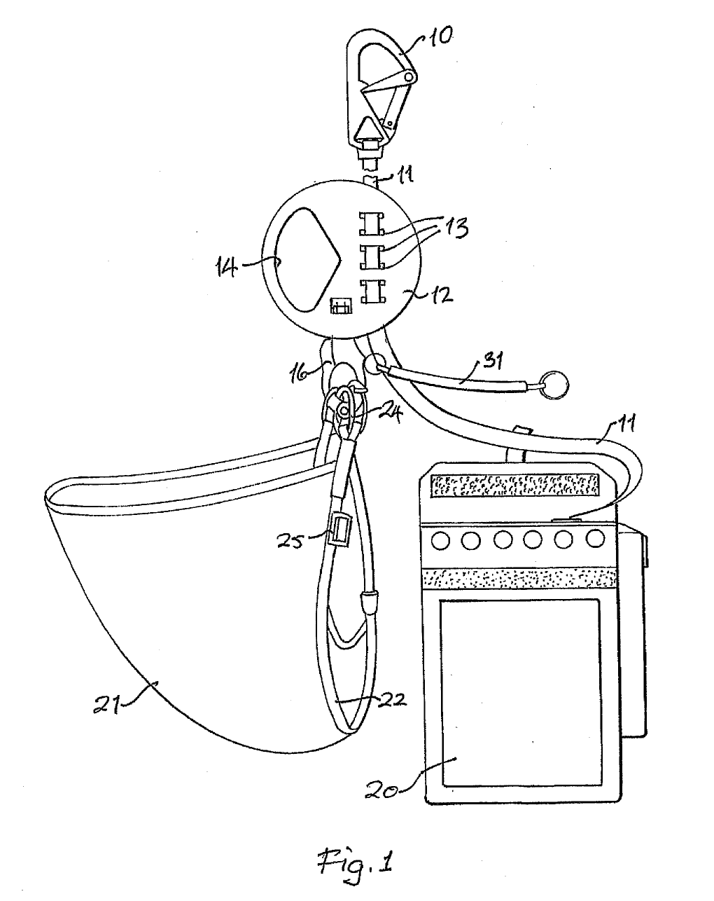

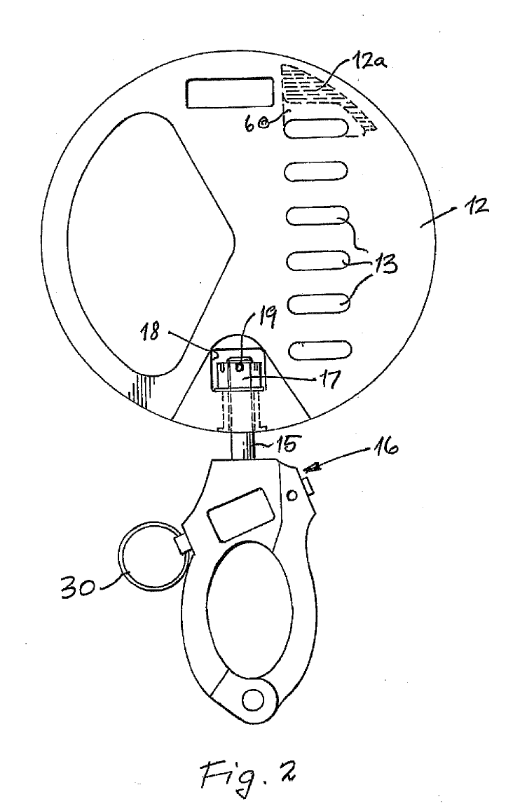

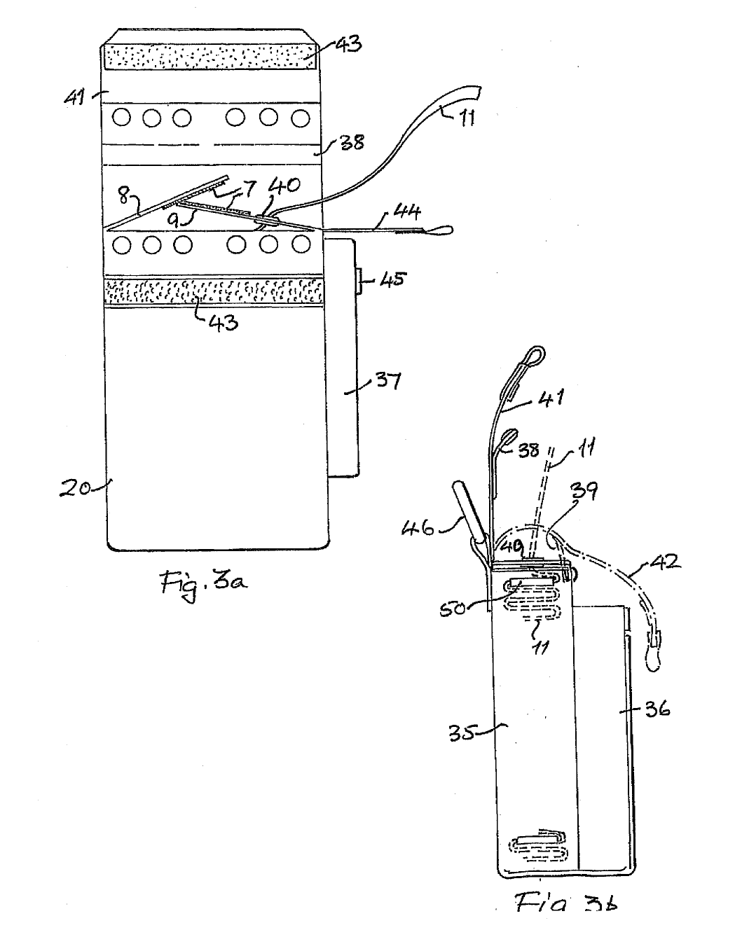

A principal component of the device is provided in the form of a disc-shaped restraining member 12 preferably of aluminium and defining a series of parallel elongate slots 13 through which the tape 11 passes alternately in opposite directions. The restraining member 12 incorporates a large aperture 14 which may serve as a hand grip. Near the base of the member 12 its thickness is increased to receive the shaft 15 (see FIG. 2) of a quick-release shackle 16 or closed shackle for on-shore use. The shaft 15 is secured by a slotted nut 17 which is received within a recess 18 in the base of the member. The nut 17 is secured by a roll pin 19. The remainder of the tape 11 below the member 12 in FIG. 1 is stored within a bag 20, details of which will be described in relation to FIGS. 3a to 3d.

The descending device is completed by a “nappy-type” harness 21 which comprises a triangular arrangement of webbing straps 22. Attachment rings 24 are provided at the three corners.

Fixed to one side strap 22 of the harness is a so-called “gear rack” 25 to which the bag or container 20 may be attached in use.

The quick-release shackle 16 is maintained in a closed condition by means of a spring-loaded catch having a pull ring 30. A short length of line 31 is attached to pull ring 30 and may carry a whistle (not shown). The line 31 is preferably attached temporarily to the harness by means of “break” beading which prevents the shackle 16 from being opened prematurely or inadvertently.

Referring now to FIGS. 3a to 3d, the container 20 comprises a first compartment 35 in which is stored a sufficient length of tape 11 for the required descent.

A further compartment 36 is large enough to contain the restraining member 12, the harness 21, the upper part of the tape 11 and the hook 10.

A further small compartment 37 on the side of the bag 20 may contain other accessories.

As seen in FIG. 3b, the first compartment 35 is closed by a rear flap 38 having press studs or similar fastenings which attach inside the top of the compartment 35 as illustrated by dotted lines 39, and by side flaps 8 and 9 extending inwardly from the sides of compartment 35 and overlapping in the lateral central region at the top of the compartment 35. Strips 7 of hook and loop fastener maintain the flaps 8 and 9 in superimposed juxtaposition when the container is closed. The side flap 9 contains a tape feed slot 40 which is centrally disposed in the flap and is designed to be of a width just narrower than the width of the tape 11 thus forming a restricted opening for the controlled payout of the tape.

A main flap 41 closes compartments 35 and 36 as illustrated by dotted line 42. Preferably, flap 41 is closed by strips 43 of hook and loop fastener.

Similarly, side compartment 37 is closed by a flap 44 with strips 45 of similar fastener.

A spring-loaded release hook 46 is provided at the rear of the container 20 for attachment to the gear rack 25 on the harness 21.

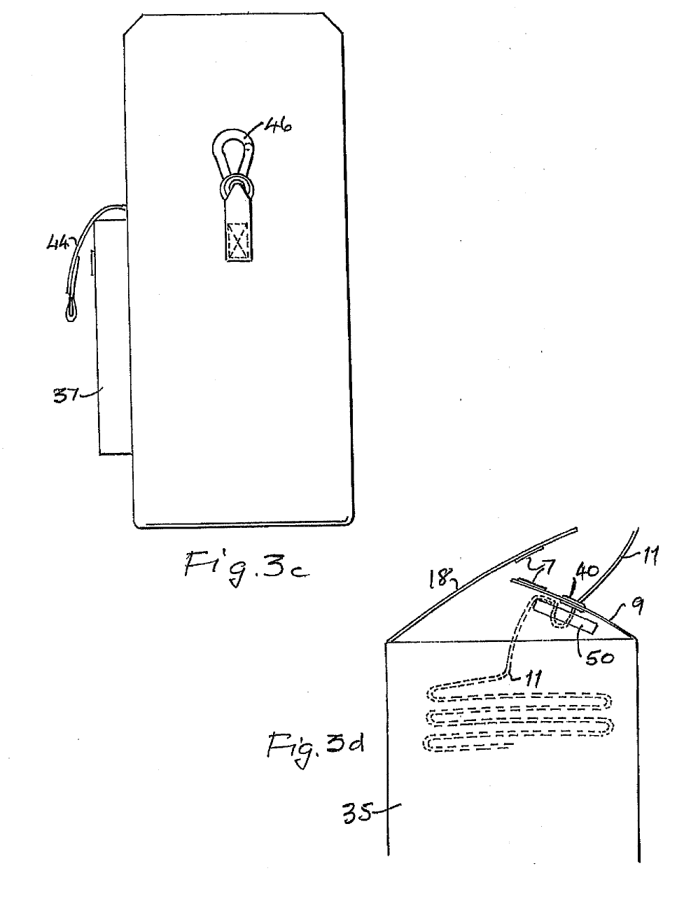

Referring now to FIGS. 3b, 3d, 4 and 5 and in accordance with the present invention, there is provided an retarding device 50 which is installed on the tape 11 within the compartment 35 of the bag 20 at a position thereon such as to retard the payout of tape from the bag through the slot 40, and thus control the rate of descent of the device. This is shown clearly in FIG. 3d

The retarding device 50, in one embodiment, comprises a body of composite alloy or aluminium with a polyester or other coating or plastics material such as nylon or polypropylene, having a pair of substantially parallel slots 51, 52 through which the tape is pre-threaded before being installed in the bag affixed to the inside of the bag parallel to aperture 40 by strips of hook and loop fastener.

The slot 51 is preferably wider than the slot 52 at some 18 mm as opposed to 16 mm for slot 52. The tape is passed initially through the slot 51 and over a central bridge 53 between the slots 51 and 52 in the direction of exit from the bag. The adjacent edges of the slots 51, 52 are rounded as shown at 54 to ease the passage of the tape through and between the slots.

In this embodiment, the retardation effect of the device 50 is afforded by the tape passing over the bridge 53 and the rounded edges 54 of the two slots. Slot 52 is slightly narrower than the width of the tape.

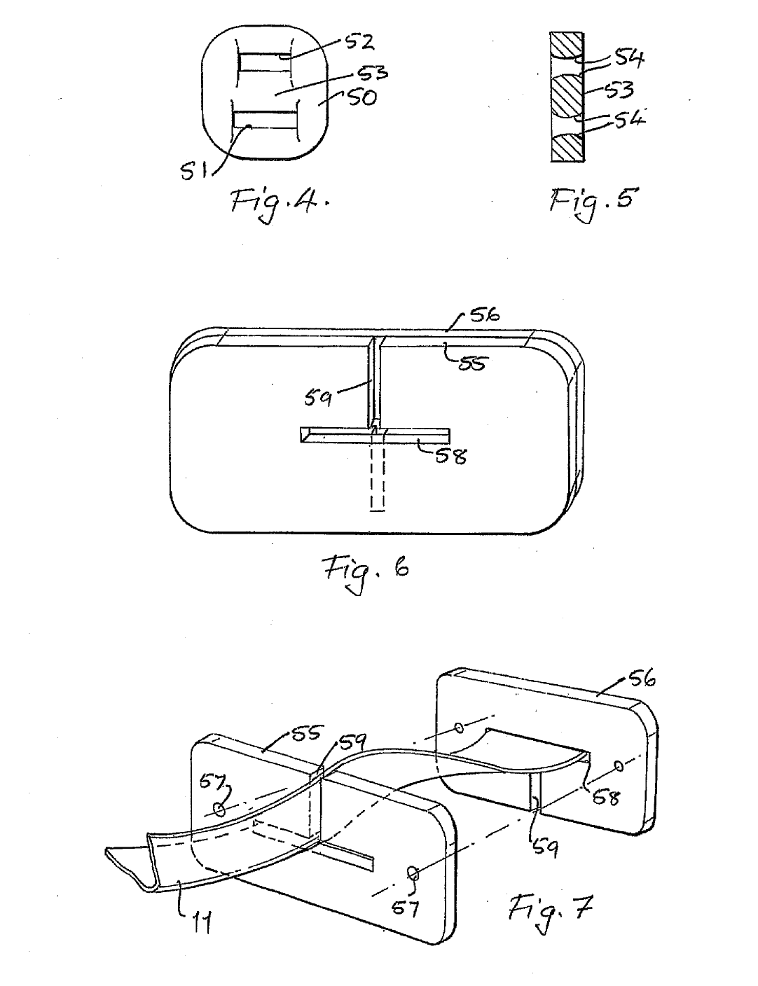

In a second embodiment as shown in FIGS. 6 and 7 the retarding device 50 comprises a pair of superimposed plates 55, 56 removably attached together, for example by a snap fitting or by screws 57, and having mutually aligned slots 58 through which the tape 11 may pass. The width of each slot 58 is typically some 16 mm, ie, approximately 4 mm less than that of the tape 11 which for most applications will be in the region of 20 mm. The depth of the slot is some 4 mm and thus approximately equal to the thickness of the tape. In this way, while the tape 11 can be pulled through the slots 58 it is nevertheless an interference fit. Each of the plates 55 and 56 has an introductory slot 59 communicating with its associated slots 58. The two plates are assembled in opposed orientation so that the introductory slot 59 of one plate is opposed to that of the other, thus when the two plates are attached together the tape cannot be removed from the slot 58. It will be seen therefore that by separating the plates 55 and 56 this form of retarding device may be retrofitted to the tape 11 of an existing descending device.

The retarding device is sufficiently compact, having an overall length and width of some 30 mm, as to be incorporated in the compartment 35 of the bag 20 where the tape is flaked as illustrated in FIGS. 3b and 3d.

The entire descending device is preferably shrink-wrapped in a transparent envelope with a quick-release sealing strip. When required for use it is taken from the envelope and the hook 10 is secured to a fixed point. The user puts on the harness and the tape 11 may be pulled through the restraining member 12 to provide sufficient free tape above the device for the user to put on the harness. Once freely suspended on the device the user may control the rate of descent by paying-out tape from the bag 20, or simply allow it to pay-out at the controlled rate determined by the restraining member 12 and retarding device 50 and the restricted opening 40 in the bag. At any time the descent may be slowed by simply applying a light hold on the tape 11 below the restraining member 12, preferably holding the tape to one side.

Referring again to FIG. 2, there is provided in the upper region of the restraining member 12 on one face thereof a toothed formation 12a which may be used, if required, to lock the device temporarily against continued descent. A raised lip 60 prevents the tape from rubbing against the toothed formation in normal use.

When it is required to arrest the descent the lower part of the tape may be looped over the restraining member 12 so that it becomes trapped between the latter and the upper part of the tape in the region of the toothed formation 12a. This will have the effect of locking the device against further descent until the free part of the tape is released.

In an alternative arrangement, two or more such retarding devices may be installed on the tape at mutually spaced positions thereon such that the first such device may control the descent and a second or subsequent one 50a may further reduce the rate of the descent. Thus, for example, the second or subsequent device 50a may further retard or arrest the descent at, say, 5 metres above the ground.

The provision of such retarding devices ensures that escaping personnel, who may be injured or unconscious, and thus unable to control the descent are safeguarded, minimising the possibility of further injury by impacting upon the ground at an uncontrolled rate.

In an offshore situation, once the user has descended to a safe level he may release the catch 16 which is so designed that, of the rings 24, one side and the front ring are released initially so that the occupant will evacuate the harness, leaving the entire device suspended on tape 11. In an on-shore situation, with a closed shackle, the occupant will either step out of the harness or, if injured, be helped out of the harness.

The purpose of the swivel connection of shackle 16 to restraining member 12 is to enable the latter to be grasped by the left or right hand selectively.

The frictional containment of the tape 11 within the restraining member 12 is such that, for example, a 250 kg load may be placed on the restraining member whilst the tape may be prevented from passing through the apertures 13 by applying a very light holding load in the region of 3 or 4 kg, or the descent stopped by passing the tape over the back of the restraining member thus locking it off and temporarily halting the descent.

The device may be readily used to lower injured persons or other loads to a lower level by another person controlling that part of the tape 11 issuing from the container 20, from the elevated position. Alternatively, the load may be attached to the hook 10 with the shackle 16 connected to the fixed point so that the entire device operates in an upside down mode.

Whilst a lightweight metallic alloy is preferred for the restraining member 12 it may be produced from a rigid plastics material with metallic inserts around the apertures 13 to dissipate heat generated by the frictional contact of the tape, and to prevent wear.

The shape of the restraining member 12 may be other than disc-like so long as it provides a plurality of contact surfaces spaced and interdisposed so as to cause the tape to travel in frictional contact over the surfaces and to change direction several times. Whilst the hand grip aperture 14 is preferable and provides a certain comfort to personnel using the device, it is not essential.

What is now claimed:

1. A descending device to enable personnel or other loads to descend from an elevated position at a controlled and variable speed, comprising a restraining member to which the load may be attached, and having therein a series of apertures through which passes in alternate directions a line such as a tape or rope, one or more edges of each aperture defining a contact surface providing frictional engagement for the line as the load descends, a means for attachment of the line to a fixed point at said elevated position, a container for a store of the line sufficient to permit the required descent and a retarding device positioned on the line at a predetermined location within the container to retard the passage of the line through the apertures of the restraining member, wherein the retarding device is provided with a pair of apertures though both of which the line passes, from one to the other, and a bridge between said pair of apertures, over which the line passes in its passage between the apertures.

2. The descending device according to claim 1, wherein the container has a restricted opening for controlled pay-out of line therefrom, the retarding device being located in the container and being larger than the restricted opening.

3. (canceled)

4. The descending device according to claim 1, wherein the size of at least one of the apertures of the retarding device is less than that of the line.

5. The descending device according to claim 4, wherein the line is a tape and at least one of the apertures of the retarding device is a slot of lesser width than that of the tape.

6. The descending device according to claim 4, wherein the retarding device is formed such that the line may be introduced into the apertures thereof without passing over the end of the line.

7. The descending device according to claim 1, wherein two or more such retarding devices are located on the line at mutually spaced positions therealong.

8. The descending device according to claim 6, wherein the retarding device has an introductory slot communicating with each aperture therein.

9-10. (canceled)

11. The descending device according to claim 1, wherein at least some of the edges of the apertures of the retarding device are rounded to ease the passage of the line through and between the apertures.

12-18. (canceled)

19. A descending device according to claim 2, wherein the retarding device is affixed to the inside of the container parallel to the restricted opening.
